(19) United States
(12) Patent Application Publication
(10) Pub. No.: US 2009/0095133 A1
(43) Pub. Date: Apr. 16, 2009

(54) METHODS, COMPOSITIONS, AND DEVICES FOR SAFE STORAGE, TRANSPORT, DISPOSAL AND RECYCLING OF MERCURY CONTAINING LIGHT BULBS

(76) Inventor: Edward T. Maggio, San Diego, CA (US)

Correspondence Address: Lisa A. Haile, J.D., Ph.D.;DLA PIPER LLP (US), 4365 Executive Drive, Suite 1100, San Diego, CA, 92121-2133, US

(21) Appl. No.: 12/249,796

(22) Filed: Oct. 10, 2008

Related U.S. Application Data
(60) Provisional application No. 61/082,047, filed on Jul. 18, 2008.
(60) Provisional application No. 60/979,675, filed on Oct. 12, 2007.

(51) Int. Cl. A62D 3/33; C22B 43/00; B65D 85/42; B65D 81/18

(52) U.S. Cl. 75/392; 588/315; 206/418; 220/560.01; 206/459.5

(57) ABSTRACT

The present invention provides methods and devices for the safe and cost efficient storage, transport and disposal of mercury. A puncture resistant container is provided having an interior element comprising a mercury sequestering substance to permit the safe storage, transport or disposal of mercury containing light bulbs and to capture mercury vapor by chemical sequestration in the event that the bulb breaks during storage, transport or disposal. The mercury sequestering element may be removable to facilitate further processing and reclamation of sequestered mercury using various methods known in the art.

### CROSS REFERENCE TO RELATED APPLICATION(S)

This application claims the benefit of priority under 35 U.S.C. § 119(e) of U.S. Ser. No. 61/082,047, filed Jul. 18, 2008, and U.S. Ser. No. 60/979,675, filed Oct. 12, 2007, the entire content of which are incorporated herein by reference.

### BACKGROUND OF THE INVENTION

1. Field of the Invention

The invention relates generally to methods and devices for the safe storage, transport, disposal, and recycling of mercury containing light bulbs.

2. Background Information

Fluorescent light bulbs are more energy efficient than incandescent bulbs and as a result are becoming increasingly used in schools, hospitals, businesses, government offices, and residences. While they are highly energy-efficient, they also contain mercury, a highly persistent and toxic chemical. When mercury-containing lamps break or are land filled or incinerated, mercury is released into our air and water, increasing the risk of exposure to humans and wildlife as the mercury progresses up the food chain. As a result, mercury is building up to dangerous levels in fish, wildlife, and human beings throughout the world. It is therefore important that such fluorescent bulbs be recycled at the end of their useful life to prevent release of the mercury into the environment. Unfortunately, fluorescent bulbs are fragile and subject to easy breakage, especially during transport before or after installation and during the disposal process. When fluorescent bulbs break, the mercury contained within the glass bulbs is released into the environment.

The amount of mercury in a fluorescent lamp can very widely, depending upon the manufacturing specifications. Some fluorescent light bulbs have as little as 3.5 mg of mercury, but some have as much a 60 mg. Over the last 20 years, the mercury content of fluorescent lamps has declined steadily as manufacturers attempt to address concerns about mercury pollution. Nevertheless, mercury is essential for current fluorescent lamps and cannot be eliminated completely so that the potential for contamination upon breakage or upon disposal remains. The elimination of mercury from the environment once it has been disbursed is extremely difficult and costly and in many cases may be impossible.

The state regulatory authorities in many states are attempting to address the potential mercury contamination issue in a variety of ways. For example, effective Feb. 8, 2006, it was no longer lawful for Californians to dispose of any mercury containing light bulbs in regular solid waste trash. The state of California recommends that its residents wrap unwanted fluorescent light bulbs in a sealed plastic bag to reduce the risk of breakage or contamination and to provide protection against cuts and to transport the spent light bulbs to a waste disposal facility qualified to handle such material. The state advises its residents not to vacuum up broken fluorescent light bulb fragments, because this can result in further dispersion of contaminated particles. Since it is not practical to travel to a waste disposal site capable of appropriately handling spent fluorescent light bulbs at all times, it becomes necessary to store the spent fluorescent light bulbs on site, whether this be in a residence or in a commercial or government building. Such on-site storage provides increased risk of light bulb breakage and mercury contamination.

Unfortunately, methods and devices for the safe and cost effective disposal of mercury have not yet been described. Thus, the need exists for improved handling of mercury to avoid potential adverse environmental impacts.

### SUMMARY OF THE INVENTION

One objective of the present invention is to provide a puncture resistant container having an interior surface coated with a mercury sequestering substance to permit the safe storage, transport or disposal of mercury containing light bulbs and to capture mercury vapor by chemical sequestration in the event that the bulb breaks during storage, transport or disposal.

Accordingly, in one embodiment, the present invention provides a device that includes a mercury impermeable container with an opening that can be sealed with an impermeable sealing means and contains a mercury sequestering agent useful for the storage, transport, or disposal of light bulbs containing mercury. In one aspect, the mercury sequestering agent is applied as a coating to the interior surfaces of the box or on a removable substrate positioned in the container which removable from the interior of the box. In another aspect, the mercury sequestering agent may be further enclosed in a mercury vapor permeable enclosure positioned in the container. The mercury vapor permeable enclosure may include a plastic mesh bag containing sulfur impregnated carbon particles in which the particles are sufficiently larger than the holes in the plastic mesh to ensure their retention within the plastic mesh bag. In various aspects, the impermeable container is fabricated from materials such as a puncture resistant polymer. Exemplary polymers include, but are not limited to TYVEK®, MYLAR®, aluminized MYLAR®, DACRON®, KEVLAR®, or a combination thereof. In other aspects, the impermeable container is fabricated from a paper product, such as card board, coated with a suitable permeation barrier layer, such a plastic, wax, and the like. In various aspects of the present invention, the mercury sequestering agent may be elemental sulfur, sulfur-impregnated activated carbon, a polymer comprising free thiol groups, activated charcoal, wood char, a zeolite, a molecular sieve, or combination thereof.

In another embodiment, the present invention provides a method of reducing the risk of environmental mercury contamination and/or preventing environmental mercury contamination. The method includes storing, transporting and/or disposing of light bulbs containing mercury using the container devices described herein including a mercury sequestering agent.

In another embodiment, the present invention provides a method of recovering released and sequestered mercury from the mercury sequestering device of the present invention. The method includes recovering sequestered mercury from the mercury sequestering agent of the container devices described herein by reclaiming the sequestered mercury through, for example, a physical or chemical reclamation process. In one aspect, the sequestering agents of the present invention may be combusted or pyrolized to free the sequestered mercury and subsequently reclaim the freed mercury.

In yet another embodiment, the present invention provides a kit including a container as described herein, configured for shipping. The container includes a mailing label preaddressed to a facility for recycling or collection of waste. The container may further include a warning label including graphics warning of hazards from mercury and handling instructions.

In yet another embodiment, the present invention provides a kit including a container as described herein, and a light bulb containing mercury. In various aspects, the container may be dimensioned for particular bulb shapes and sizes or may be integrally associated with the bulb and provided as a coating or bulb sleeve.

### DETAILED DESCRIPTION OF THE INVENTION

The present invention is based on methods and devices for the safe and cost efficient storage, transport and disposal of mercury. Accordingly, the invention provides methods for preventing environmental mercury contamination, as well as suitable devices for practicing the methods described herein. Puncture resistant containers are described, including a mercury sequestering substance to permit the safe storage, transport or disposal of mercury containing light bulbs and to capture mercury vapor by chemical sequestration in the event that the bulb breaks during storage, transport or disposal.

Before the present devices and methods are described, it is to be understood that this invention is not limited to particular devices, methods, and experimental conditions described, as such devices, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an” and “the” include plural references unless the context clearly dictates otherwise. Thus, for example, references to “the method” includes one or more methods, and/or steps of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

Accordingly, in one embodiment, the present invention provides a container device that allows for transport, storage and/or disposal of mercury containing light bulbs. The device includes a container impermeable to mercury with a sealable opening, which is impermeable to mercury when sealed. The device further includes a mercury sequestering agent within the container.

As used herein, the term “bulb” is intended to include any light bulb which contains mercury, such as mercury-vapor lamps which are gas discharge lamps using mercury in an excited state to produce light.

As used herein, the term “mercury sequestering agent” is intended to include any agent that is suitable for use in sequestering mercury. Such sequestering is typically through binding or complexation of the agent with mercury ions to form a complex. However, the mercury sequestering agent may act though any process so long as the agent and mercury interact such that the mercury becomes complexed to the agent.

An exemplary type of mercury sequestering agent suitable for use with the present invention is elemental sulfur. Elemental sulfur may be provided in any form, such as a powder or thin film which can be adhered to an interior container surface via a suitable adhesive.

Another type of mercury sequestering agent suitable for use with the present invention is sulfur-impregnated activated carbon. Activated carbon may be prepared as described in U.S. Pat. No. 3,194,629, the entirety of which is incorporated by reference. For example, 10 grams of sulfur-impregnated activated carbon may be prepared by impregnating the carbon with 3 grams of sulfur dissolved in 20 CC of carbon disulfide and the mixture evaporated to dryness. The sulfur treated activated carbon is known to absorb mercury vapor quantitatively.

Yet another type of mercury sequestering agent suitable for use with the present invention includes polymers having free thiol groups exposed to permit a reaction and sequestration of mercury, such as, but not limited to styrene polymers containing pendant ethanethiol moieties. For example, such polymers are described in U.S. Pat. No. 4,021,416, the entirety of which is incorporated herein by reference. Additional examples of free-thiol containing polymers suitable for use with the present invention are described in references 1, 2 and 7, the entirety of which are incorporated herein by reference. In another exemplary aspect, molecules with free thiols are particularly efficient at sequestering mercuric ions formed upon oxidation of elemental mercury.

Additional types of sequestering agents are known to complex or sequester mercury. Accordingly, additional agents suitable for use with the present invention include, and are not limited to: activated charcoal; wood char; and hydrated aluminosilicate minerals having a micro-porous structure, such as, zeolites and molecular sieves.

In various aspects, the mercury sequestering agent may be included in the container in a variety of configurations, such that the agent may act to sequester mercury which is released within the container. In one aspect, the agent is applied as a coating to the interior surface of the container. Additionally, the agent may be applied to a substrate which is configured in the container and may be subsequently removed from the container. Accordingly, in various aspects the agent may be applied in the form of a coating, or may be coated on the separate solid phase element which may be included separately inside the container. A variety of coating methods are known in the art and suitable for applying the agent as a coating or otherwise. Typically, the agent may be mixed with a binder to form a solution or suspension and applied in a variety of methods. Suitable binders may include, but are not limited to water soluble or organic soluble glues or adhesives, polymers, starches, proteins, inks, and latex suspension. Alternatively, the agent may be applied as a powder. For example, the coating may be applied by methods such as, but not limited to, spray coating, printing methodologies, powder coating with an adhesive, or dip coating. Additionally, the agent may be prepared in a film, such as a polymeric layer, that is laminated to the internal surfaces of the container or used to coat the removable substrate.

Accordingly, in various aspects, the present invention includes producing coatings containing mercury sequestering agents, that may be applied to surfaces likely to come in contact with contaminating mercury. The mercury sequestering agent may be deposited directly on the interior surface of the container or may alternatively be deposited on a suitable substrate that may be included within the container. Suitable substrates may be in the form of a single-ply paper, multi-ply paper, or woven or non-woven fabric, flexible foam sponge-like material, and the like. The substrate may be flat or may be formed into a more complicated shape. For example, it may be fluted, to increase the reactive surface area containing the sequestering agent. Examples of substrate configurations that may be utilized with the present invention have been used to hold adhered substances in applications such as release of fabric-conditioning agents. For example, U.S. Pat. No. 4,557,852, discloses a water-insoluble sheet formed from a synthetic acrylate-type polymer which encloses a fabric softener or bleach. Additionally, U.S. Pat. No. 3,936,538, discloses a fabric-softening composition for use in the dryer consisting of a sheet of a film-forming polymer.

To maximize the absorption of mercury, the largest possible portion of the interior of the container should be covered with the sequestering substance. Additionally, the sequestering capacity of the coating should exceed the total mercury content present in the mercury containing light bulb on a molar basis. Typically the sequestering substance would be capable of binding and sequestering an amount of mercury in excess of three to 10 mg or more as needed on a mole per mole basis. In an exemplary aspect, the molar binding capacity of the sequestering substance is a multiple of the molar mercury burden present within the bulb.

An other aspects of the invention, the container device includes a mercury vapor permeable enclosure containing the sequestering agent. The enclosure may be removable to facilitate further processing of sequestered mercury, such as reclaiming the mercury using various methods known in the art. The sequestering agent may be configured in the enclosure in a variety of configurations. As discussed herein, the agent may be incorporated within the permeable enclosure in a variety of ways.

In an exemplary aspect, the mercury permeable enclosure is configured as a mesh bag or equivalent configuration that encloses the sequestering agent. The plastic mesh may be formed into bags using a variety of means including, but not limited to an ultrasonic sealing machine provided, heat sealer, or an adhesive. In one aspect, mesh that is suitable for use in the present invention is plastic nylon mesh, such as that supplied by CORES Htech Co. Ltd., of Daegu, Korea and designated by the supplier as “Nylon Mesh for Pyramid Tea Bag”.

Monofilament nylon mesh is one of several examples of the types of plastic materials that may be used to enclose the mercury sequestering agent, such as sulfur impregnated carbon particles. For example a variety of plastics and/or polymeric materials are suitable for fabricating the mercury permeable enclosure, such as the mesh bag.

As used herein, plastic is intended to include a wide range of polymeric synthetic or semisynthetic organic materials and is intended to be synonymous with the term “polymer” or “polymeric material”. Typical plastics may include, but are not limited to a polyolefin, polypropylene, polyethylene, polycondensate, polyamide, polyester, polycarbonate, polymethylmethacrylate, polyarylate, polyacrylate, polyacetal, polyimide, cellulose ester, polystyrene, fluoropolymer, polyphenylenesulfide, or mixtures thereof. Combinations of polymers may also be used to form plastics, such as copolymers and polymer blends. Fluoropolymers may also be used, such as, polytetrafluoroethylene (PTFE) and perfluorinated ethylene/propylene copolymer (PFEP).

In various aspects, the present invention provides permeable enclosures containing a sequestering agent included within the container. The permeable enclosures may be made of polymeric materials, such as certain plastics, including and not limited to polystyrene, polypropylene, polyethylene, and the like that facilitate further processing of the sequestered mercury due to the chemical structure of the plastic. For example, unlike nylon, these latter polymers contain no hetero atoms such as nitrogen. Upon pyrolysis or combustion they yield substantially only CO₂ and H₂O as combustion products, thus making the recovery of the liberated mercury compounds simpler and suitable for standard commercial reprocessing technologies for mercury. Such processes include thermal, chemical and physical treatment systems such as, but not limited to high vacuum mercury waste retort systems. For example, a large commercial mercury recovery waste reprocessor that may be used to process solid and liquid mercury bearing wastes, such as the sequestered mercury of the present invention, is Bethlehem Apparatus in Hellertown, Pa.

In various exemplary aspects, sulfur impregnated carbon particles are used as the mercury sequestering agent. Suitable carbon particles may be employed of varying sizes and characteristics. For example, some suitable carbon particles are those distributed as FILTRASORB®, MERSORB®, and ADA POWER PAC PREMIUM®. In an exemplary aspect, those marketed as FILTRASORB® and distributed by NUCON International, Inc., are utilized.

In various aspects, a variety of sizes and shapes of carbon particle may be utilized. For example, carbon particles suitable for use with the present invention may have diameters from about 0.5 to about 5.5 mm. For example, particle diameters may be about 0.5, 1, 1.5, 2, 2.5, 3, 3.5, 4, 4.5, 5, 5.5 or even greater than about 6 mm. When carbon particles are utilized in the permeable mesh bag configuration, the particle size should be large enough to prevent the particle from falling through the holes in the mesh. In an exemplary embodiment, a particle having a cylindrical shape and having a diameter of about 1.5 mm and a length of approximately 1 to 4 mm is utilized (MERSORB® 1.5). As shown in the Examples presented herein, MERSORB® 1.5 has been found to be effective in sequestering mercury discharged from light bulbs. Similar to other carbon particles, MERSORB® 1.5 is effective due in part because the particles exhibit excellent physical stability and do not shed significant amounts of carbon dust. Additionally, the particles remain intact with normal manipulation and handling that occurs during the manufacturing process and that which would be expected in use of the carbon particle as described herein so that the sequestered mercury will remain inside the mesh bag enclosure.

In various aspects, a variety of materials are envisioned for use in fabricating the container component of the present invention so long as the resulting container is impermeable to mercury. In an exemplary aspect, the material is puncture resistant so as to avoid rupture of the container by glass shards produced by a ruptured light bulb. For example, the material may include a puncture resistant plastic and/or polymer as described herein, such as MYLAR® or aluminized MYLAR®. Other puncture resistant plastics include TYVEK®, distributed by DuPont, which has found many uses in protection, security and safety in a wide variety of industries, including protective apparel, construction, envelopes, medical and industrial packaging, and graphics, and which serves as a satisfactory substrate for coating mercury sequestering substances. Other plastics and/or polymeric materials as defined herein, including, DACRON® and KEVLAR® may be employed. Additionally, coated paper products, such as paperboard, cardboard, and the like may also be used as a puncture resistant material suitable for fabrication of the container device. In various aspects, a material, or combination of materials may be utilized. For example, the container may be fabricated from combinations of materials such as laminates. Additionally, the container may be fabricated such that the container is substantially rigid or is flexible depending on the desired application.

The container device of the present invention may be fabricated in a variety of dimensions and shapes sufficient to accommodate various standard bulb dimensions. For example, the container may be suitably dimensioned to hold one or more table lamp bulbs. Alternatively, the container may be dimensioned to include long cylindrical bulbs. A variety of standard bulb sizes are well known in the art.

The container device of the present invention includes a sealable opening, such that the container is substantially impermeable to mercury when the opening is sealed. A variety of sealable openings are suitable for use with the container device. In one aspect, the opening may be mechanically sealed by closures, such as, but not limited to cable ties, twist ties, strings, elastic bands, and the like. Additionally, the opening may be sealed by employing an adhesive, such as an adhesive strip and/or contact adhesive to seal the opening. Further, the opening may be sealed by interlocking closures, such as, but not limited to zippers, similar to those used on resealable “zip lock” type bags. In various aspects, the opening may be sealed by one or a combination of closure features known in the art.

In another aspect, the present invention provides substantially transparent or translucent containers, configured for use as a coating or sleeve for a light bulb that contains mercury and which is being used in daily operation. The container device may be configured to physically contact the bulb during operation of the bulb. In various aspects, the container device may be configured as a sleeve or coating with sufficient structural integrity such that upon breakage of the bulb, the plastic coating or film remains intact and serves to sequester the mercury that would otherwise be released into the environment. In one aspect, the container material may be applied directly to the surface of the bulb thus forming the container. For example, polymer and/or plastic coatings or films, containing polymeric substances including free thiol groups or other sequestering agents may be applied directly to the surface of the bulb and remain intact upon breakage of the bulb.

In another aspect, the present invention provides a container as described herein, wherein the sequestering agent is suitable to allow recovery of the mercury by a retort process, wherein the sequestering agent is heated in order to volatilize the mercury which may then be recaptured by condensation or chemical extraction. As discussed herein, specific plastics may be utilized in various aspects of the invention which facilitate further processing of the sequestered mercury due to the chemical structure of the plastic. For example, plastics that contain no hetero atoms such as nitrogen are suitable to allow recovery of the mercury by a retort process which includes heating of the plastics to volatize sequestered mercury, such as pyrolysis or combustion, Upon pyrolysis or combustion they yield substantially only CO₂ and H₂O as combustion products, thus making the recovery of the liberated mercury compounds simpler and suitable for standard commercial reprocessing technologies for mercury. Accordingly, the present invention provides a method for recovering sequestered mercury from a device described herein, comprising combusting or pyrolizing the sequestering agent and reclaiming the released mercury to recover the sequestered mercury.

In another aspect, the invention provides a kit including a mercury containing light bulb and a container device as described herein. For example, the kit facilitates the safe disposal, transport and storage of mercury containing bulbs. The container device may further include a preaddressed mailing label. The preaddressed mailing label is addressed to an approved recycling or collection center to facilitate proper recycling and handling of mercury containing light bulbs. The container may further include additional labeling including instructions for proper handling and disposal of discarded mercury containing bulbs.

In another aspect, the invention provides a kit including a container device as described herein with a preaddressed mailing label. In an exemplary aspect, the container is a puncture resistant shipping container intended to meet the shipping requirements of the US Postal Service or the requirements of private shipping services such as FedEx, UPS, DHL and the like, and may contain a shock absorbing foam or air bubble packing liner. The preaddressed mailing label is addressed to an approved recycling or collection center to facilitate proper recycling and handling of mercury containing light bulbs. The container may further include additional labeling including instructions for proper handling and disposal of discarded mercury containing bulbs.

The following examples are intended to illustrate but not limit the invention.

### EXAMPLE 1

### Sequestration of Mercury Using Carbon Particles

This example illustrates sequestration of mercury using carbon particles.

A nylon mesh bag of dimensions 10×10 cm was constructed using “Nylon Mesh for Teabag” provided by CORES Htech Co. Ltd., of Daegu, Korea by cutting and sewing the nylon mesh. Mercury sorbent, 1 gram of MERSORB® 1.5, provided by NUCON International Inc., Columbus, Ohio was inserted inside the bag and the opening was sealed. A similar bag was constructed, but without addition of the mercury sorbent. Each bag was placed into a separate TYVEK® shipping envelope and a 13 Watt mercury containing fluorescent light bulb was placed into each bag and the bags were sealed. The bulb in each bag was crushed and the bags were allowed to remain undisturbed for 24 hours. At the end of this time, each envelope was opened and into each bag was inserted a mercury sampler foam disc model SKC No. 520-ANASORB®, supplied by SKC Inc., of PA in order to detect any residual unsequestered mercury. After an additional 24 hours, the foam discs were sent to LA Testing Inc., Los Alamitos, Calif., for measurement of residual mercury. The foam disc placed into the TYVEK® envelope that contained the control nylon mesh bag had a mercury content of 1.1 mcg. The detection limit of the laboratory assay is 0.050 mcg. The foam disc placed into the TYVEK® shipping envelope that contained the nylon mesh bag with MERSORB® 1.5 Mercury sorbent had a mercury content less than the detectable limit of 0.050 mcg.

### EXAMPLE 2

### Sequestration of Mercury Using Carbon Particles

This example illustrates sequestration of mercury using carbon particles.

A TYVEK® shipping envelope was held in an open position and an area of approximately 10×10 cm was coated with rubber cement. MERSORB® 1.5 particles or ground in a mortar and pestle into a fine powder and sprinkled on the rubber cement before it was dry. After the rubber cement dried, excess powder was removed from the TYVEK® shipping envelope by vigorous shaking. A similar TYVEK® bag was used as the no-sorbent control. A 13 Watt mercury containing fluorescent light bulb was placed into each bag and the bags were sealed. The bulb in each bag was crushed and the bags were allowed to remain undisturbed for 24 hours. At the end of this time, each envelope was opened and into each bag was inserted a mercury sampler foam disc model SKC No. 520—ANASORB®, supplied by SKC Inc., in order to detect any residual unsequestered mercury. After an additional 24 hours, the foam discs were sent to LA Testing Inc., Los Alamitos, Calif., for measurement of residual mercury. The foam disc placed into the TYVEK® that contained the control nylon mesh bag had a mercury content in 1.7 mcg. The detection limit of the laboratory assay is 0.050 mcg. The foam disc played into the TYVEK® shipping envelope that contained the nylon mesh bag with MERSORB® 1.5 Mercury sorbent had a mercury content less than the detectable limit of 0.050 mcg.

Throughout this application, various publications are referenced. The disclosures of these publications in their entireties are hereby incorporated by reference into this application in order to more fully describe the state of the art to which this invention pertains.
1. Peka, et al., Angewandte Makromolekulare Chemie 44 (1), 67-75 (1975).
2. Yamashita et al., Journal of Polymer Science Part A: Polymer Chemistry, 29 (5), 777-779 (1991).
3. U.S. Pat. No. 4,021,416.
4. U.S. Pat. No. 3,194,629.
5. U.S. Pat. No. 4,557,852.
6. U.S. Pat. No. 3,936,538.
7. Carrillo et al., Nanotechnology, 16 S416-S421(2005).

Although the invention has been described with reference to the above example, it will be understood that modifications and variations are encompassed within the spirit and scope of the invention. Accordingly, the invention is limited only by the following claims.

What is claimed is:

1. A device comprising:
a) a container impermeable to mercury;
b) a sealable opening on the container, wherein the opening is impermeable to mercury when sealed; and
c) a mercury sequestering agent within the container.

2. The device of claim 1, wherein the container comprises a puncture resistant polymer, a paper product coated with a permeation barrier, or combination thereof.

3. The device of claim 2, wherein the puncture resistant polymer is TYVEK®, MYLAR®, aluminized MYLAR®, DACRON®, KEVLAR®, or a combination thereof.

4. The device of claim 1, wherein the opening is sealable using a contact adhesive band, an interlocking closure, a cable tie, an elastic band, a twist tie, or a combination thereof.

5. The device of claim 1, wherein the mercury sequestering agent is elemental sulfur, sulfur-impregnated activated carbon, a polymer comprising free thiol groups, activated charcoal, wood char, a zeolite, a molecular sieve, or a combination thereof.

6. The device of claim 1, wherein the mercury sequestering agent is deposited directly on the interior surface of the container.

7. The device of claim 1, wherein the mercury sequestering agent is deposited on a removable substrate within the container.

8. The device of claim 1, wherein the mercury sequestering agent is deposited on an interior surface of the container or on a substrate removable from the container by spray coating, printing, powder coating with an adhesive, dip coating, or laminating.

9. The device of claim 1, wherein the mercury sequestering agent is mixed with a suitable binder as a suspension or a solution.

10. The device of claim 1, wherein the stoichiometric binding capacity of the device is able to sequester from at least about 3.5 mg to about 60 mg of mercury.

11. The device of claim 1, wherein the container is dimensioned to accommodate a standard fluorescent light bulb.

12. The device of claim 1, further comprising a warning label on the exterior of the device.

13. The device of claim 12, wherein the warning label comprises graphics warning of hazards from mercury and broken glass.

14. The device of claim 1, wherein the device is configured for use with a fluorescent light bulb being used in daily operation and capable of remaining in physical contact with the bulb during operation.

15. The device of claim 14, wherein the device is applied directly to the exterior of the bulb as a coating which sequesters mercury upon breakage of the bulb.

16. The device of claim 14, wherein the device is configured as a sleeve which sequesters mercury upon breakage of the bulb.

17. A method of reducing the risk of environmental mercury contamination comprising storing, transporting or disposing of light bulbs comprising mercury using the device of claim 1, thereby reducing the risk of environmental mercury contamination.

18. A kit comprising a fluorescent light bulb and the device of claim 1.

19. The device of claim 1, wherein the mercury sequestering agent is enclosed in a mercury vapor permeable enclosure.

20. The device of claim 19, wherein the mercury vapor permeable enclosure comprises a mesh bag and the mercury sequestering agent is sulfur impregnated activated carbon particles having a particle size larger than the holes in the mesh.

21. The device of claim 20, wherein the mesh bag is fabricated from a plastic.

22. The device of claim 21, wherein the plastic is nylon.

23. The device of claim 19, wherein the mercury sequestering agent is sulfur impregnated activated carbon.

24. The device of claim 23, wherein the carbon is extruded carbon particles impregnated with elemental sulfur.

25. The device of claim 24, wherein the mercury sequestering agent has a particle size from about 0.5 mm to about 5 mm in size.

26. The device of claim 20, wherein the mesh bag is removable from the impermeable container to permit extraction of sequestered mercury.

27. The device of claim 26, wherein the mesh bag is combusted or pyrolyzed to recover sequestered mercury.

28. A method of recovering sequestered mercury from the device of claim 19, wherein the mesh bag comprises a polymer that yields substantially only H₂O and CO₂ when combusted, comprising combusting or pyrolizing the mesh bag and reclaiming the released mercury, thereby recovering the sequestered mercury.

29. A method of recovering sequestered mercury from the device of claim 1, wherein the sequestering agent comprises a polymer that yields substantially only H₂O and CO₂ when combusted, comprising combusting or pyrolizing the polymer and reclaiming the released mercury, thereby recovering the sequestered mercury.

30. A kit comprising the container of claim 1, and further comprising a preaddressed mailing label and a warning label.

31. The kit of claim 30, wherein the preaddressed mailing label is addressed to a recycling or collection center.

32. The kit of claim 30, wherein the warning label comprises graphics warning of hazards from mercury and handling instructions.
